(19) United States
(12) Patent Application Publication
(10) Pub. No.: US 2006/0219629 A1
(43) Pub. Date: Oct. 5, 2006

(54) Oil and water separator

(76) Inventor: Andrew Noestheden, Tecumseh (CA)

Correspondence Address: GIFFORD, KRASS, GROH, SPRINKLE & CITKOWSKI, P.C, PO BOX 7021, TROY, MI, 48007-7021, US

(21) Appl. No.: 11/094,891

(22) Filed: Mar. 31, 2005

(51) Int. Cl. B01D 17/025

(52) U.S. Cl. 210/519; 210/540

(57) ABSTRACT

An oil and water separator having a tank with a tank chamber and a cover extending over the top of the tank chamber. A supply pipe extends vertically with respect to the tank chamber so that its lower end is positioned adjacent the bottom of the tank chamber while its upper end is spaced upwardly from the cover. An oil/water mixture inlet is fluidly connected to the upper end of the supply pipe. A water outlet is positioned above the cover and fluidly connected to the bottom of the tank chamber by a water collection pipe. An oil outlet chamber is also positioned above the cover and has its bottom open to the tank chamber.

### BACKGROUND OF THE INVENTION

I. Field of the Invention

The present invention relates generally to fluid separators and, more particularly, to an oil and water separator. Furthermore, as used herein, the term “oil” shall mean any material that is immiscible with water.

II. Description of Related Art

In many manufacturing operations, such as those utilized by the automotive industry, debris together with oils must be cleaned from manufactured parts by directing power water sprays at the manufactured parts at a cleaning station. Such power industrial sprays effectively clean the parts, but result in an oil and water mixture which is then removed from the cleaning station.

Environmental laws and regulations, as well as general common sense, however, prevent the disposal of the oil and water mixture resulting from the cleaning operation into municipal sewage systems. Consequently, it is necessary to process the effluent from the cleaning station in an effort to separate the oil and water from each other, in order to recycle them separately.

There have been previously known oil and water separators for processing the effluent from industrial cleaning stations. However, these previously known oil and water separators have not proven wholly satisfactory in use.

One disadvantage of these previously known oil and water separators is that the tank utilized to separate the oil from the water typically includes an open top that is exposed to the atmosphere. In an industrial environment this kind of open-air tank acts as a trap for not only airborne pollution, but also small animals like bugs, spiders, mice and rats. Then, after extended usage, bacteria and other microbes in the atmosphere multiply within the oils and greases within the separator thus resulting in not only a foul smelling oil and water separator, but also a potential health hazard.

A still further disadvantage of these previously known oil and water separators is that such separators have been bulky in size. In many situations, however, factory floor space is limited thus rendering the use of such oil and water separators impractical.

A still further disadvantage of these previously known oil and water separators is that such oil and water separators have not proven wholly satisfactory in operation. Instead, even the “clean” water outlet from the oil and water separator oftentimes contains an unacceptably high level of oil contaminants.

### SUMMARY OF THE PRESENT INVENTION

The present invention provides an oil and water separator which overcomes all of the above-mentioned disadvantages of the previously known devices.

In brief, the oil and water separator of the present invention comprises a tank defining a tank chamber. A cover extends over and preferably covers the top of the tank chamber.

A supply pipe extends vertically with respect to the tank chamber. A lower end of the supply tank is open to and positioned adjacent the bottom of the tank chamber. Conversely, the upper end of the supply pipe is spaced upwardly from the cover. In addition, at least one, and preferably several, openings are formed through the supply pipe at a position between the bottom or lower end of the supply pipe and the cover.

An oil/water mixture inlet is fluidly connected to the upper end of this flow supply pipe. Preferably, a weir is fluidly disposed in between the oil/water mixture inlet and the supply pipe.

A water outlet housing having a water outlet chamber is positioned above the cover. This water outlet chamber is fluidly connected by a water collection pipe to a lower end of the tank chamber. Similarly, an oil outlet housing having an oil outlet chamber is also positioned above the cover. A bottom of the oil outlet chamber is open to the tank chamber. In order to remove the separated oil and water from the separator, an oil effluent conduit is fluidly connected to the oil outlet chamber and, similarly, a water effluent conduit is fluidly connected to the water outlet chamber.

In practice, during the inflow of an oil/water mixture into the oil/water mixture inlet, the weir produces an initial conglomeration of the oil particles before the mixture is introduced into the supply pipe. Thereafter, the oil/water mixture and the partly conglomerated oil particles flow downwardly through the supply pipe.

Since oil has a lesser density than water, the oil particles tend to float on water and, for that reason, do not reach the lower end of the supply pipe. Instead, the oil together with some intermixed water flows out through the openings in the supply pipe and into the tank chamber. Conversely, only water flows outwardly through the bottom of the supply pipe. Consequently, after a period of use, the liquid within the tank chamber is roughly defined into three layers. The bottommost layer comprises essentially pure water while the upper layer comprises largely conglomerated oils and greases. Lastly, the middle layer within the tank chamber comprises a mixture of oil and water and, as the oil separates from the water, the separated oil gravitates upwardly to form the oil-rich upper layer.

A water outlet housing having a water outlet chamber is positioned above the cover. This water outlet chamber is fluidly connected by a water collection pipe to the bottom of the tank chamber. Consequently, only essentially pure water flows from the bottom of the tank chamber, through the water collection pipe and into the water outlet chamber. A water effluent conduit then is fluidly connected to the water outlet chamber to remove the separated water.

Similarly, an oil outlet housing defining an oil outlet chamber is also positioned above the cover. This oil outlet chamber has its bottom open to the tank chamber so that the conglomerated oil and grease particles in the upper tank layer flow into the oil outlet chamber. An oil effluent conduit is then fluidly connected to the oil outlet chamber to remove the separated oil.

### BRIEF DESCRIPTION OF THE DRAWING

A better understanding of the present invention will be had upon reference to the following detailed description, when read in conjunction with the accompanying drawing, wherein like reference characters refer to like parts throughout the several views, and in which:

FIG. 1 is a perspective view illustrating a preferred embodiment of the present invention; and

FIG. 2 is a cross-sectional view illustrating the preferred embodiment of the present invention.

### DETAILED DESCRIPTION OF A PREFERRED EMBODIMENT OF THE PRESENT INVENTION

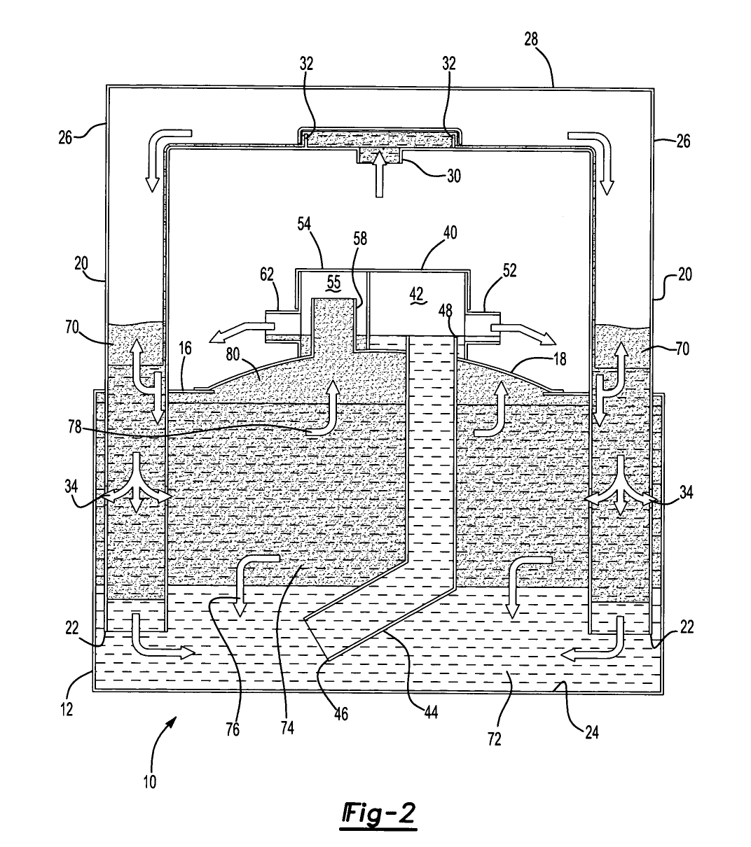

With reference to the drawing, a preferred embodiment of an oil and water separator 10 according to the present invention is shown. The oil and water separator 10 includes a generally rectangular tank 12 defining a tank chamber 14. A cover 16 extends over and preferably covers the tank chamber 14. Additionally, a removable center portion 18 of the cover 16 is preferably upwardly concavely curved as best shown in FIG. 2 for a reason to be subsequently described.

At least one and preferably two supply pipes 20 are mounted to the tank 12 so that the supply pipes 20 extend generally vertically with respect to the tank 12. A lower end 22 of each supply pipe 20 is open to the tank chamber 14 adjacent a bottom 24 of the tank chamber 14. Conversely, the upper ends 26 of the supply pipes 20 extend upwardly above the cover 16.

The supply pipes 20 are preferably spaced apart and generally parallel to each other and are preferably mounted adjacent one side 21 of the tank 12. A horizontal supply pipe 28 then extends across and fluidly connects the upper ends 26 of the supply pipes 20 together.

An oil/water mixture inlet 30 (FIG. 2) is open to the bottom of the horizontal supply pipe 28 preferably along the center of the horizontal supply pipe 28. An oil/water mixture is fluidly connected to the inlet 30 so that the oil/water mixture is pumped into the horizontal supply pipe 28 by any conventional means.

A weir 32 is provided on each side of the oil/water inlet 30 so that each weir 32 is fluidly positioned in between the inlet 30 and one of the supply pipes 26. The operation of the weir will be subsequently described.

With reference now particularly to FIG. 2, at least one and preferably several openings 34 are formed in each supply pipe 20 at a position spaced downwardly from the tank cover 16 and spaced upwardly from the bottom 22 of each supply pipe 20. Although the precise position of the holes 34 will vary between different applications, the holes 34 are preferably substantially halfway between the tank cover 16 and the bottom 22 of the supply pipe 20.

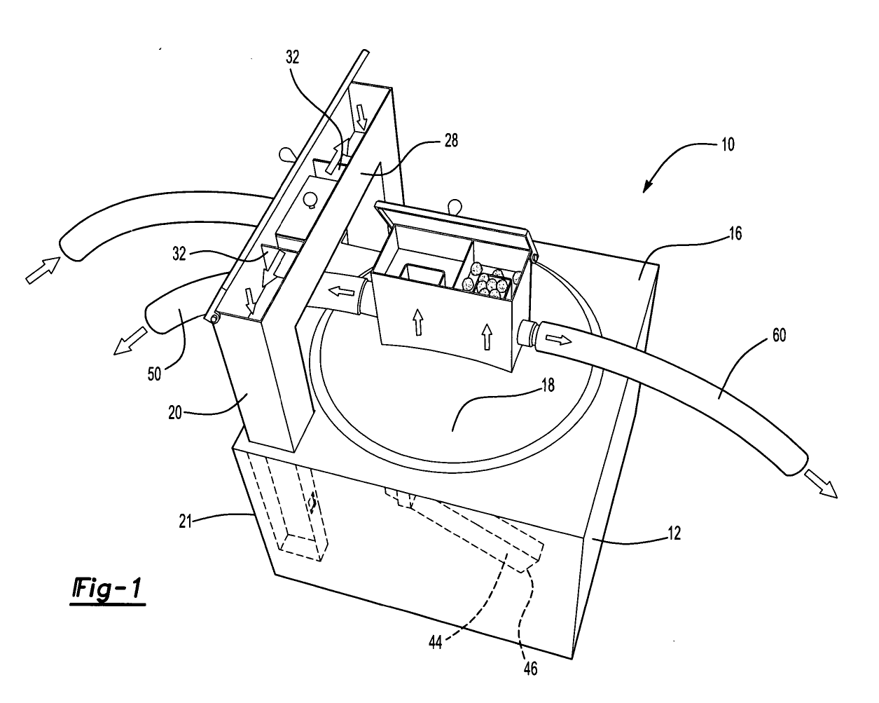

A water outlet housing 40 defining a water outlet chamber 42 is mounted on the center removable portion 18 of the cover 16. A water collection pipe 44 has its lower end 46 fluidly opened to the tank chamber 14 adjacent the tank bottom 24. In addition, as best shown in FIG. 1, the lower end 46 of the water collection pipe 44 is disposed at the side of the tank 12 opposite from the supply pipes 20.

An upper end 48 of the water collection pipe 44 is open to the water outlet chamber 42. Additionally, a water effluent conduit 50 (FIG. 1) is fluidly connected to the water outlet chamber 42 through a port 52.

An oil outlet housing 54 defining an oil outlet chamber 55 is also mounted to the cover 16 and preferably adjacent the water outlet housing 40 and near or at the top of the concave portion 18 of the cover 16. A bottom of the oil outlet chamber 55 is open to the top of the tank chamber 14 through a spout 58. An oil effluent conduit 60 (FIG. 1) is then fluidly connected to the oil outlet chamber 55 through a port 62.

In operation, an oil/water mixture is pumped into the water/oil inlet 30 where the influent first flows across the weirs 32 and into the horizontal supply pipe 28. In doing so, the weirs 32 cause an initial separation of the oil from the water and partial conglomeration of the oil particles by maintaining a substantially constant and minimal thickness of the influent flow over the weirs 32.

After flowing over the weirs 32, the influent passes into the supply pipes 20. As is well known, oil has a lower density than water and, for that reason, floats on top of the water. Consequently, after extended use of the oil and water separator 10, a conglomeration 70 of oil will form at a position aligned with the oil outlet port 62. Consequently, as the continuing influent passes downwardly from the upper end 26 of the supply pipe and through the conglomerated oil 70, the conglomerated oil will effectively capture at least a portion of the oils from the influent.

A portion of the oil/water mixture, although with a lesser concentration of oil, passes through the oil conglomeration 70 through the supply pipe 20. However, the flow rate of the influent into the inlet 30 is maintained so that the oil/water mixture does not reach the bottom 22 of the supply pipes 20. Instead, the now lower oil concentration oil/water mixture flows outwardly through the openings 34 formed in the supply pipes 20.

After reaching equilibrium, the fluid contained within the tank chamber 14 is roughly divided into three different layers. The lowermost layer 72 comprises essentially pure water which flows outwardly through the bottom 22 of the supply pipes 20. This relatively pure water 72 is conveyed up through the water collection pipe 44 to the water outlet chamber 42 and out through the water effluent conduit 60 in the desired fashion.

An oil/water emulsion strata 74 is then positioned immediately above the water layer 72. The oil/water strata 74 contains the mixture of oil and water under emulsion form, received through the openings 34 in the supply pipes 20. Once the oil/water mixture flows out through the openings 34 and into the middle strata 74, the oil particles, due to their lower density than water, continue to separate from the ambient water. In doing so, water flows downwardly, as indicated by arrow 76, into the lowermost water strata 72. Simultaneously, the lighter oil particles gravitate upwardly as indicated by arrow 78 then agglomerate and form an upper oil layer 80 within the tank chamber 14.

This upper oil layer 80 is fluidly open to the oil outlet chamber 55 through the spout 58. Furthermore, the upwardly concave portion 18 of the housing cover 16 channels the flow of separated oil into the oil outlet chamber 55. The separated oil is then removed from the oil outlet chamber 55 through the oil effluent conduit 60 and either recycled or disposed of in any conventional fashion.

From the foregoing, it can be seen that the present invention provides a simple and yet highly effective oil and water separator which is particularly useful for industrial applications. Having described my invention, however, many modifications thereto will become apparent to those skilled in the art to which it pertains without deviation from the spirit of the invention as defined by the scope of the appended claims.

I claim:

1. An oil and water separator comprising:
a tank having a tank chamber,
a cover extending over a top of said tank chamber,
a supply pipe extending vertically with respect to said tank chamber, said supply pipe having a lower end open to and positioned adjacent a bottom of said tank chamber, an upper end spaced upwardly from said cover and having at least one opening at a position between said bottom of said tank and said cover,
an oil/water mixture inlet fluidly connected to said upper end of said supply pipe,
a water outlet chamber positioned above said cover,
a water collection pipe having a lower end open to said tank chamber adjacent said bottom of said tank chamber and an upper end fluidly connected to said water outlet chamber, and
an oil outlet chamber positioned above said cover, said oil outlet chamber having a bottom open to said tank chamber.

2. The invention as defined in claim 1 and comprising a pair of supply pipes, said supply pipes being parallel and spaced apart from each other.

3. The invention as defined in claim 2 and comprising a horizontal supply pipe extending between and fluidly connected to said supply pipes.

4. The invention as defined in claim 3 wherein said oil/water mixture inlet is fluidly connected to said horizontal supply pipe.

5. The invention as defined in claim 4 and comprising a weir fluidly disposed in said horizontal supply pipe and fluidly between said oil/water mixture inlet and said supply pipes.

6. The invention as defined in claim 1 and comprising a weir fluidly positioned between said oil/water mixture inlet and said supply pipe.

7. The invention as defined in claim 1 and comprising a plurality of openings formed through said supply pipe at said position between said bottom of said supply pipe and said cover.

8. The invention as defined in claim 1 wherein said cover has a removable upwardly concavely formed portion, said oil collection chamber being open to a top of said removable concavely formed portion.

9. The invention as defined in claim 8 and comprising an effluent housing secured to said removable upwardly concavely formed cover, said water outlet chamber and said oil outlet chamber being formed in said effluent housing.

10. The invention as defined in claim 1 and comprising a water effluent conduit fluidly connected to said water outlet chamber.

11. The invention as defined in claim 1 and comprising an oil effluent conduit fluidly connected to said oil outlet chamber.

12. The invention as defined in claim 4 wherein the oil-water mixture inlet is fed by a low rotation speed fluid pump located underneath the oil separator tank.

13. The invention as defined in claim 12 where the low rotation speed pump is itself connected to the main oil-water emulsion tank through a skimmer.
